(19) United States
(12) Patent Application Publication
(10) Pub. No.: US 2019/0185049 A1
(43) Pub. Date: Jun. 20, 2019

(54) Steering Rack

(71) Applicants: Robert Bosch Automotive Steering LLC, Florence, KY (US); Robert Bosch GmbH, Stuttgart (DE)

(72) Inventor: Dennis Nemeth, Florence, KY (US)

(21) Appl. No.: 16/195,391

(22) Filed: Nov. 19, 2018

Related U.S. Application Data
(60) Provisional application No. 62/599,387, filed on Dec. 15, 2017.

(51) Int. Cl. B62D 3/12; F16H 55/26

(52) U.S. Cl. CPC B62D 3/126; F16H 55/26

(57) ABSTRACT

A steering rack having a toothed member and a base body each extending along longitudinal axis comprising: a toothed region disposed on the toothed member extending along the longitudinal axis; a first contact area disposed on the tooth member extending along the longitudinal axis; a first toothed member end area disposed at a first longitudinal end of the toothed member and a second toothed member end area disposed at a second longitudinal end of the toothed member; a receptacle disposed on the base body, the receptacle configured to accept the toothed member; a second contact area disposed on the base body extending along the longitudinal axis, the first and second contact areas being attached to each other; and a first receptacle end area disposed on the base member at a first longitudinal end of the receptacle and a second receptacle end area at a second longitudinal end of the receptacle, wherein the first receptacle end area and the first toothed member end area are attached to each other, and wherein the second receptacle end area and the second toothed member end area are attached to each other.

### BACKGROUND

The present invention relates to vehicle steering systems, and more particularly to a steering rack construction.

### SUMMARY

In some aspects a steering rack is provided having a toothed member and a base body each extending along longitudinal axis comprising: a toothed region disposed on the toothed member extending along the longitudinal axis; a first contact area disposed on the tooth member extending along the longitudinal axis; a first toothed member end area disposed at a first longitudinal end of the toothed member and a second toothed member end area disposed at a second longitudinal end of the toothed member; a receptacle disposed on the base body, the receptacle configured to accept the toothed member; a second contact area disposed on the base body extending along the longitudinal axis, the first and second contact areas being attached to each other; and a first receptacle end area disposed on the base member at a first longitudinal end of the receptacle and a second receptacle end area at a second longitudinal end of the receptacle, wherein the first receptacle end area and the first toothed member end area are attached to each other, and wherein the second receptacle end area and the second toothed member end area are attached to each other. The first receptacle end area and the first toothed member end area define a first end seam on an outer surface of the steering rack and the second receptacle end area and the second toothed member end area define a second end seam on the outer surface of the steering rack. The first and second contact areas define two contact surfaces seams extending along the longitudinal axis between the first and second end seams on the outer surface of the steering rack. The seams define a closed loop. The base body has a first base body region adjacent the receptacle defining a first outer circular sector having a first radius from the longitudinal axis, extending along the longitudinal axis and away from the first receptacle end area and a second base body region adjacent the second receptacle end area defining a second outer circular sector having a second radius from the longitudinal axis, extending along the longitudinal axis and away from the receptacle, wherein the toothed member has a first outer member region between the first toothed member end area and the toothed region and a second outer member region between the second toothed member end area and the toothed region, and wherein the first outer member region has the same first radius as the first outer circular sector and the second outer member region has the same second radius as the second outer circular sector. The first and the second radius are identical. Two contact surfaces seams are arranged in a plane which is parallel to the longitudinal axis. The base body is a tube with a tube wall and the two contact surfaces seams are arranged in a plane with a radial distance to the longitudinal axis. The base body is a tube with a tube wall and the two contact surfaces seams are arranged in a plane in which the longitudinal axis is arranged. The toothed member has angled areas between the outside teeth and the first and second member regions defining partial elliptical surfaces. The first receptacle end area and the first toothed member end area and the second receptacle end surface and the second toothed member end area are radially extending and parallel to each other. The toothed member has wall segments extending along the longitudinal axis arranged on either side of the teeth of the toothed section and ending in the toothed member end areas. The first end seam and the second end seam define circular sectors on the outer surface of the steering rack. The toothed member and the base body are welded together. Advantages of the proposed steering rick may be a reduction in weight with an optimized material utilization. It is also suitable for high volume applications. Simple tube concepts and existing production equipment may be used. This design may allow the use of high strength, high cost, or thicker materials only in the areas needed. Further advantages may be cost savings by reducing expensive materials. A performance improvement may also be obtained with less mass to accelerate or decelerate during steering.

### BRIEF DESCRIPTION OF THE DRAWINGS

FIG. 1 is a longitudinal section of a steering rack assembly according to one embodiment of the invention.

FIG. 2 shows a steering rack of the steering rack assembly of FIG. 1, wherein

FIG. 2A is a perspective view of the steering rack,

FIG. 2B shows an exploded view of the steering rack of FIG. 2A,

FIG. 2C shows a top view of the steering rack of FIG. 2A,

FIG. 2D shows a first cross section along the lines IId-IId in FIG. 2A and

FIG. 2E shows a second cross section along the lines IIe-IIe in FIG. 2A.

FIG. 3 shows perspective view of a steering rack according to a second embodiment of the invention, wherein

FIG. 3A shows a perspective view of the steering rack,

FIG. 3B shows a first cross section along the lines IIIb-IIIb in FIG. 3A and

FIG. 3C shows a second cross section along the lines IIIc-IIIc in FIG. 3A.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

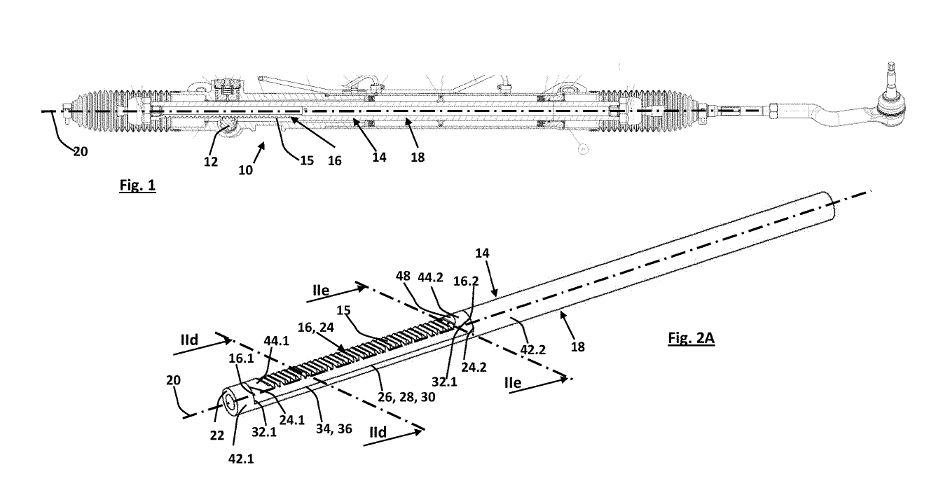

A longitudinal section of a steering rack assembly 10 is shown in FIG. 1. The steering rack assembly 10 includes a pinion 12 and a steering rack 14. The pinion 14 is in engagement with teeth 15 of a toothed member 16 of the steering rack 14. The steering rack 14 has the shape of a tube. But other cross sections are also possible.

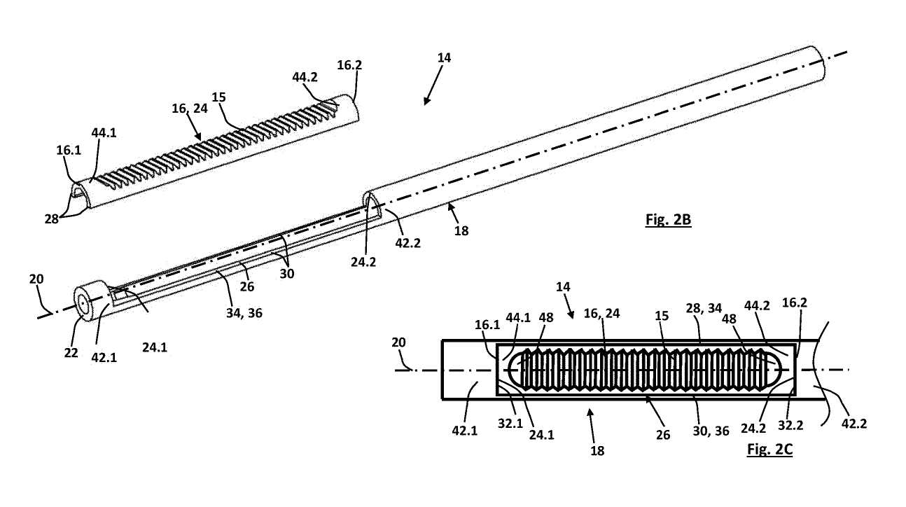

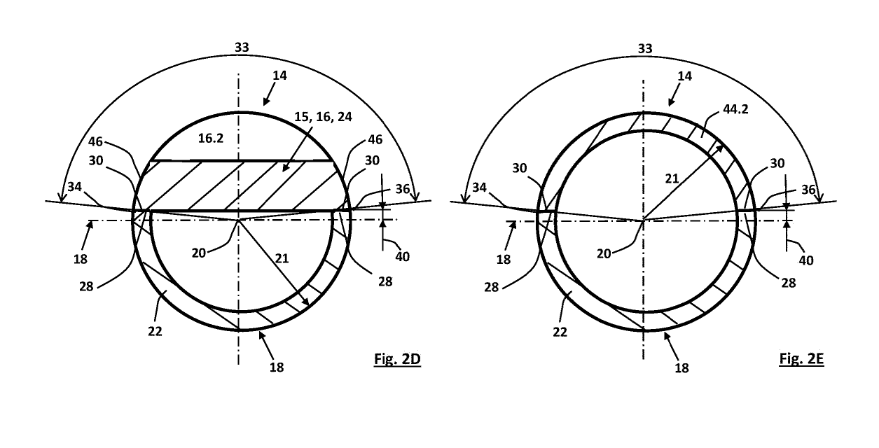

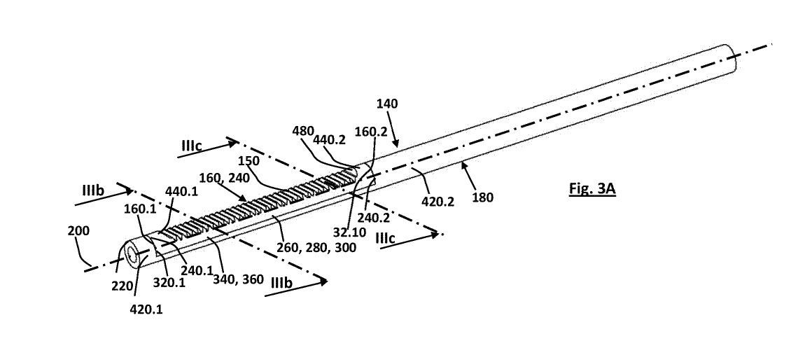

As can be better seen in FIG. 2, the toothed member 16 is attached to a base body 18 of the steering rack 14. The toothed member 16 and the base body 18 are welded together. The toothed member 16 and the base body 18 may be laser welded but other methods may also be applied. The steering rack 14 has a longitudinal axis 20. The base body 18 is made from a circular tube with an outer radius 21 and a tube wall 22 but other cross sections may also be used. The wall thickness may be between 3-4 mm. In areas such as the ends of the steering rack 14 it can be thicker such as for example around 24 mm so inner tie rods can be inserted.

The toothed member 16 has a toothed region 24 extending along the longitudinal axis 20. The base body 18 has a recess extending along the longitudinal axis 20 and defining a receptacle 26 in which the toothed member 16 is arranged.

The toothed member 16 has a first contact area 28 extending along the longitudinal axis 20 and the receptacle 24 has a second contact area 30 extending along the longitudinal axis 20. The first and second contact areas 28, 30 are attached to each other. The receptacle 24 has a first receptacle end area 24.1 at a first longitudinal end of the receptacle 24 and a second receptacle end area 24.2 at its second longitudinal end. The toothed member 16 has a first toothed member end area 16.1 at a first longitudinal end of the first member 16 and a second toothed member end area 16.2 at its second longitudinal end. The first receptacle end area 24.1 and the first toothed member end area 16.1 are attached to each other. The second receptacle end area 24.2 and the second toothed member end area 16.2 are also attached to each other. The first receptacle end area 24.1 and the first toothed member end area 16.1 as well as the second receptacle end area 24.2 and the second toothed member end area 16.2 are radially extending and parallel to each other. As shown in FIG. 2, the end areas 24.1, 16.1 and 24.2, 16.2 are flat surfaces. But they could also be rounded, angled or shaped differently depending on the need.

The first receptacle end area 24.1 and the first toothed member end area 16.1 define a first end seam 32.1 on an outer surface of the steering rack 14. The second receptacle end area 24.2 and the second toothed member end area 16.2 define a second end seam 32.2 on the outer surface of the steering rack 14. The first end seam 32.1 and the second end seam 32.2 define circular seam sectors extending over an angle 33 of the outer surface of the steering rack 14. The angle 33 is about 170° around the longitudinal axis 20 but could range from 120° to 180°. The first and second axial contact areas 28, 30 define two contact surfaces seams 34, 36 extending along the longitudinal axis 20 between the first and second end seams 32.1, 32.2 on the outer surface of the steering rack 14. The seams 32.1, 32.2, 34, 36 define a closed loop (FIG. 2C). This results in a smooth surface of the steering rack 14. The two contact surfaces seams 34, 36 are arranged in a plane 38 which is parallel to the longitudinal axis 20. Furthermore, the two contact surfaces seams 34, 36 are arranged in the plane 38 with a radial distance 40 to the longitudinal axis 20. The seams 32.1, 32.2, 34, 36 are obtained through a welding operation. Therefore, the first receptacle end area 24.1 and the first toothed member end area 16.1, the second receptacle end area 24.2 and the second toothed member end area 16.2 as well as the first and second axial contact areas 28, 30 are attached to each other along their respective seams 32.1, 32.2, 34, 36 but contact each other on the remaining parts of the surfaces.

The base body 18 has a first base body region 42.1 adjacent the receptacle 24 defining a first outer circular sector extending along the longitudinal axis 20 and away from the receptacle 24. The first outer circular sector has the radius 22 from the longitudinal axis 20 but could also have a different first radius. The base body 18 has a second base body region 42.2 adjacent the receptacle 24 defining a second outer circular sector extending along the longitudinal axis 20 and away from the receptacle 24, hence in an opposite direction of the first base body region 42.1. The first outer circular sector has the radius 22 from the longitudinal axis 20 but could also have a different second radius. The toothed member 16 has a first member region 44.1 between the first toothed member end area 16.1 and the toothed region 24 and a second member region 44.2 between the second toothed member end area 16.2 and the toothed region 24. The first member region 44.1 has the same first radius as the first outer circular sector of the first base body region 42.1. The second member region 44.2 has the same second radius as the second outer circular sector of the second base body region 42.2. The first and second radius are identical but could be different from each other. This results in contiguous neighboring surfaces after a welding operation which reduces mechanical stress. In the embodiment shown the first and second outer circular sectors have the same radius since the base body 18 of the steering rack 14 is made from a tube. But they could be of different dimensions or shapes. The outer circular sectors of the first and second base body region 42.1, 42.2 as well as the outer radius of the first and second member regions 44.1, 44.2 extend over the angle 33 around the longitudinal axis 20. Axially extending side areas 46 of the teeth 15 extending along the longitudinal axis 20 are also on radius 21. The toothed member 16 has angled areas 48 between the outside teeth and the first and second member regions 44.1 and 44.2. In the embodiment shown these angled areas 48 define partial elliptical surfaces.

The receptacle 24 can be laser cut or manufactured by another suitable cutting operation such as milling or stamping. The toothed member 16 can be cut from a round material with a saw which makes two D-shaped parts. These can then be inserted into receptacles 24 and finally attached with a weld operation. Then the teeth 15 can be cut prior to the toothed member 16 being inserted in and attached to the receptacle 24 or afterwards. This can also be used for the second embodiment described below. Other processes for manufacturing the toothed member may be a wobbling process, cold or warm forging, stamping from flat sheet, broaching from solid material, grinding from solid material or powdered metal. Further manufacturing steps for the steering rack 14 may be grinding, end finishing (threading), heat treatment and straightening.

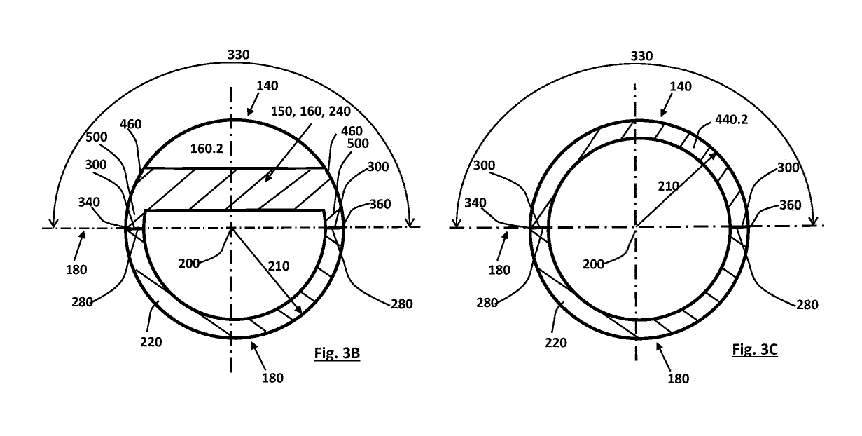

FIG. 3 shows a second embodiment of a steering rack 140. The steering rack 140 is tubular with a tube wall 220. The steering rack 140 also has a toothed member 160 and a base body 180. The steering rack 140 extends along a longitudinal axis 200 and has an outer radius 210. The toothed member 160 is arranged in a receptacle 260 of the base body and has a toothed region 240. The toothed member 160 has a first contact surface 280 extending along the longitudinal axis with which it is attached to a second contact area 300 of the receptacle 240 also extending along the longitudinal axis. The receptacle 240 has a first receptacle end area 24.1 and a second receptacle end area 24.2. The toothed member 160 has a first toothed member end area 160.1 and a second toothed member end area 160.2. The first receptacle end area 240.1 is attached to the first toothed member area 160.1 and define a first end seam 320.1. The second receptacle end area 240.2 is attached to the second toothed member end area 160.2 to define a second end seam 320.2. The first and second end seams 320.1 and 320.2 extend over an angle 330 of 180° around the longitudinal axis 200. The first and second contact surfaces 280, 300 define contact surfaces seams 340, 360. The contact surfaces seams 340, 360 are arranged in a plane 380. The axis 200 lies in the plane 380.

The base body 180 has a first base body region 420.1 adjacent the receptacle 240 defining a first outer circular sector 420.1 extending along the longitudinal axis and away from the receptacle 240. The base body 180 has a second base body region 420.2 adjacent the receptacle 240 defining a second outer circular sector extending along the longitudinal axis 200 and away from the receptacle 240 opposite the direction of the first base body region 420.1. The toothed member 160 has a first member region 440.1 between the first toothed member end area 160.1 and the toothed region 240 and a second member region 440.2 between the second toothed member end area 160.2 and the toothed region 240. The first member region 440.1 has the same first outer circular sector as the first base body region 420.1. The second member region 440.2 has the same second outer circular sector as the second base body region 420.2.

The toothed member 160 has wall segments 500, 520 extending along the longitudinal axis and being arranged on either side of teeth 150 of the toothed section 160 and that end in the first contact area 280. Axially extending side areas 460 of the teeth 150 extending along the longitudinal axis 200 which are also the side areas of the wall segments 500, 520 also are on radius 210. The toothed member 160 has angled areas 480 between the outside teeth 150 and the first and second member regions 440.1 and 440.2. In the embodiment shown these angled areas 480 define partial elliptical surfaces.

What is claimed is:

1. A steering rack having a toothed member and a base body each extending along longitudinal axis comprising:
a toothed region disposed on the toothed member extending along the longitudinal axis;
a first contact area disposed on the tooth member extending along the longitudinal axis;
a first toothed member end area disposed at a first longitudinal end of the toothed member and a second toothed member end area disposed at a second longitudinal end of the toothed member;
a receptacle disposed on the base body, the receptacle configured to accept the toothed member;
a second contact area disposed on the base body extending along the longitudinal axis, the first and second contact areas being attached to each other; and
a first receptacle end area disposed on the base member at a first longitudinal end of the receptacle and a second receptacle end area at a second longitudinal end of the receptacle,
wherein the first receptacle end area and the first toothed member end area are attached to each other, and wherein the second receptacle end area and the second toothed member end area are attached to each other.

2. A steering rack according to claim 1,
wherein the first receptacle end area and the first toothed member end area define a first end seam on an outer surface of the steering rack and the second receptacle end area and the second toothed member end area define a second end seam on the outer surface of the steering rack.

3. A steering rack according to claim 2,
wherein the first and second contact areas define two contact surfaces seams extending along the longitudinal axis between the first and second end seams on the outer surface of the steering rack.

4. A steering rack according to claim 3,
wherein the seams define a closed loop.

5. A steering rack according to claim 1,
wherein the base body has a first base body region adjacent the receptacle defining a first outer circular sector having a first radius from the longitudinal axis, extending along the longitudinal axis and away from the first receptacle end area and a second base body region adjacent the second receptacle end area defining a second outer circular sector having a second radius from the longitudinal axis, extending along the longitudinal axis and away from the receptacle,
wherein the toothed member has a first outer member region between the first toothed member end area and the toothed region and a second outer member region between the second toothed member end area and the toothed region, and
wherein the first outer member region has the same first radius as the first outer circular sector and the second outer member region has the same second radius as the second outer circular sector.

6. A steering rack according to claim 5,
wherein the first and the second radius are identical.

7. A steering rack according to claim 5,
wherein the two contact surfaces seams are arranged in a plane which is parallel to the longitudinal axis.

8. A steering rack according to claim 7,
wherein the base body is a tube with a tube wall and the two contact surfaces seams are arranged in a plane with a radial distance to the longitudinal axis.

9. A steering rack according to claim 7,
wherein the base body is a tube with a tube wall and the two contact surfaces seams are arranged in a plane in which the longitudinal axis is arranged.

10. A steering rack according to claim 7,
wherein the toothed member has angled areas between the outside teeth and the first and second member regions defining partial elliptical surfaces.

11. A steering rack according to claim 1,
wherein the first receptacle end area and the first toothed member end area and the second receptacle end surface and the second toothed member end area are radially extending and parallel to each other.

12. A steering rack according to claim 1,
wherein the toothed member has wall segments extending along the longitudinal axis arranged on either side of the teeth of the toothed section and ending in the toothed member end areas.

13. A steering rack according to claim 1,
wherein the first end seam and the second end seam define circular sectors on the outer surface of the steering rack.

14. A steering rack according to claim 1,
wherein the toothed member and the base body are welded together.
